(19) United States
(12) Patent Application Publication
(10) Pub. No.: US 2010/0176850 A1
(43) Pub. Date: Jul. 15, 2010

(54) DEVICE FOR CONVERTING AN ELECTRIC CURRENT

(75) Inventor: Marcos Pereira, Erlangen (DE)

Correspondence Address: LERNER GREENBERG STEMER LLP, P O BOX 2480, HOLLYWOOD, FL, 33022-2480, US

(73) Assignee: SIEMENS AKTIENGESELLSCHAFT, Munchen (DE)

(21) Appl. No.: 12/667,566

(22) PCT Filed: Jun. 16, 2008
(86) PCT No.: PCT/EP08/57557

§ 371 Date: Jan. 4, 2010

(30) Foreign Application Priority Data
Jul. 2, 2007 (DE) 10 2007 031 140.2

(51) Int. Cl. G05F 3/08

(52) U.S. Cl. 327/109

(57) ABSTRACT

A device for converting an electric current or for forming an electric voltage, Includes semiconductor modules connected in series and having at least one controllable power semiconductor, a high-voltage control unit lying at the potential of one of the semiconductor modules and a low-voltage control unit lying close to a ground potential and connected to the high-voltage control unit by at least one fiber-optic cable. The device is to be safe, low-maintenance and cost-effective and therefore the high-voltage control unit has a high-voltage interface lying at the potential of one of the semiconductor modules and connected to at least two controllable power semiconductors by signal lines and the high-voltage interface is connected to the low-voltage control unit by at least one of the fiber-optic cables.

The invention relates to a device for converting an electric current or for forming an electric voltage comprising series-connected semiconductor modules having at least one drivable power semiconductor, comprising a high-voltage control unit at the potential of one of the semiconductor modules, and comprising a low-voltage control unit close to ground potential, said low-voltage control unit being connected to the high-voltage control unit by means of at least one optical waveguide.

Such a device is already known from U.S. Pat. No. 5,969,956. The device described therein is a converter that is part of a high-voltage direct-current transmission (HVDCT) system. The converter shown therein has valve branches each having a series circuit formed by semiconductor modules. The semiconductor modules each comprise a thyristor, which can be changed over by an electrical triggering pulse from an off-state position, in which a current flow via the thyristor is interrupted, to an on-state position, in which a current flow via the thyristor is made possible. A regulating device serves for triggering the thyristors. The regulating device comprises a high-voltage control unit at a high-voltage potential and also a low-voltage control unit close to ground potential, which are connected to one another by means of potential-isolating optical waveguides. The electrical signals of the low-voltage control unit are therefore converted into optical signals and transmitted to the high-voltage control unit via the optical waveguide. The high-voltage control unit has an optoelectric transducer that converts the received optical signals into electrical signals. The received signals provide for expedient triggering of the thyristors. Furthermore, state monitoring sensors are assigned to each thyristor, said sensors monitoring the state of the respectively assigned thyristor with state data being obtained in the process. The state data are finally transmitted to the high-voltage control unit, the latter processing the state data at least in part and transmitting the data obtained during processing to the low-voltage control unit via the optical waveguides.

Converters comprising a series circuit formed by semiconductor modules are also known from the practical implementation of power transmission and distribution. By means of the series circuit, the voltage present at the terminals of the series circuit is distributed among the individual semiconductor modules. In this way it is possible to provide converter valves which are designed for a high voltage, even though the dielectric strength of the individual semiconductor modules is limited. In high-voltage applications, the number of semiconductor modules required is in the range of a few 10 to more than 1000. The semiconductor modules comprise for example an individual drivable power semiconductor or else a capacitor and a plurality of power semiconductors connected up to one another to form a half- or full-bridge. The power semiconductors generally have to be driven accurately and rapidly. As has already been explained further above, in accordance with the prior art each power semiconductor is connected to a controller close to ground potential via in general two optical waveguides. This has the disadvantage that a very large number of optical waveguides are required. In the case of a redundant design of the controller, the number of optical waveguides furthermore additionally increases above a factor of two. Moreover, it is difficult for all the data which are obtained during monitoring and are transmitted via the respective optical waveguides to be processed centrally in the required time.

Therefore, it is an object of the invention to provide a device of the type mentioned in the introduction which is reliable, involves little outlay and is cost-effective.

The invention achieves this object by virtue of the fact that the high-voltage control unit has a high-voltage interface, which is at the potential of one of the semiconductor modules and is connected to at least two drivable power semiconductors via signal lines, the high-voltage interface being connected to the low-voltage control unit via at least one of said optical waveguides.

The invention provides a high-voltage interface which receives the data transmitted by the low-voltage control unit and distributes them further to a plurality of power semiconductors. In this case, the high-voltage interface is at the potential of the semiconductor switches. For this reason, the high-voltage interface can be arranged in direct spatial proximity to the semiconductors, with the result that the signal lines leading to the power semiconductors, such as electrical data lines and optical data lines for example, can be designed in correspondingly short and cost-effective fashion. Furthermore, the device according to the invention requires only a reduced number of optical waveguides between the high-voltage interfaces and the low-voltage control unit with the consequence of a reduction of the costs of the device according to the invention. For suitable further distribution, the data transmitted by the low-voltage control unit expediently have a response address stipulating to which of the power semiconductors the high-voltage interface forwards the data or signals. In the context of the invention, the transmitted data can be both analog but also preferably digital data that are sent in the form of data messages.

In the context of the invention, the term drivable power semiconductor should be understood to mean any power semiconductor which proves to be expedient for use in the area of high voltage. Merely by way of example, therefore, mention shall be made of thyristors, so-called GTOs (Gate Turn-Off Thyristor), IGCT (Integrated Gate Commutated Thyristor), GCT (Gate Commutated Turn-Off Thyristor) and IGBT (Insulated Gate Bipolar Transistor). A semiconductor module has for example just one of these power semiconductors. In a departure from this, a semiconductor module in the context of the invention has a plurality of drivable and, if appropriate, also non-drivable power semiconductors which are connected up to one another to form a half- or full-bridge. The semiconductor module can furthermore also comprise further components such as capacitors. In the context of the invention, power semiconductor should be understood to mean the smallest drivable unit. In this case, each power semiconductor comprises a plurality of semiconductor chips contact-connected to one another in any desired manner.

In accordance with one preferred configuration of the invention, each high-voltage interface is connected to at least four drivable power semiconductors. The four drivable power semiconductors are connected up to one another to form a full-bridge, with which a capacitor is connected in parallel.

Advantageously, the high-voltage interface is designed for receiving control signals via an optical waveguide connected to it and for distributing the received control signals to the power semiconductors connected to it.

One advantageous further development of the device according to the invention provides state sensors connected to the high-voltage interface, such that the high-voltage interface receives measurement signals of the state sensors. The high-voltage interface also acts as a simple distributor, for example, with regard to the measurement signals of the state sensors, the measurement signals being forwarded to the low-voltage control unit.

Each low-voltage control unit is connected only to the high-voltage interface via the optical waveguides. Some other connection between the low-voltage control unit and a component of the device according to the invention at high-voltage potential is not provided.

In accordance with one preferred configuration, the high-voltage interface is designed for processing the measurement signals of the state sensors and for driving the power semiconductors connected to it in a manner dependent on the measurement signals. In other words, the high-voltage interface performs functions that are otherwise carried out by the low-voltage control unit. This therefore results in a great simplification for the entire control of the device according to the invention. Reactions to measurement signals of the semiconductor switches which have to take place in an extremely short time, for example in the range of microseconds, can be carried out independently and locally more efficiently by the high-voltage interface. The burden on the low-voltage control unit is relieved in this way.

Advantageously, provision is made of a power supply unit close to ground potential, said power supply unit being connected to the high-voltage interface via potential-isolating connecting means, such that the power supply in the high-voltage interface is provided by the power supply unit close to ground potential.

In accordance with one expedient further development, provision is made of a high-voltage power supply which is at the potential of one of the semiconductor modules and which is designed for the power supply of the high-voltage interface.

The semiconductor modules comprise, as has already been explained, turn-off and/or non-turn-off power semiconductors, such as thyristors for example. While thyristors can actively only be changed over from the interrupter position to the on-state position, it is possible in the case of turn-off power semiconductors, such as IGBTs, for these also actively to be changed over from the on-state position to the off-state position by means of a drive signal. It goes without saying that this extends the control possibilities for the semiconductor switches. Turn-off power semiconductors generally have a freewheeling diode reverse-connected in parallel.

In the context of the invention, light-drivable power semiconductors are provided, for example, which can be driven by means of an expedient light signal. In a departure from this, electrically controllable power semiconductors are provided in the context of the invention.

In a further configuration of the invention, each drivable power semiconductor is connected to the high-voltage interface via a so-called gate unit, the gate unit being designed for electrically driving the drivable power semiconductors of the semiconductor module. The gate unit thus serves for driving the electrically addressable power semiconductors. In this case, the gate unit is generally directly connected to the semiconductor switch. The high-voltage interface is provided for addressing the gate unit, such that the latter generates the necessary control signals for the power semiconductor connected to it. Gate units are known as such, however, and so they need not be discussed in detail at this point.

In accordance with one expedient further development in this regard, the high-voltage interface is set for the power supply of the gate unit. The outlay on cabling in the device according to the invention is also reduced even further as a result of this interconnection between the gate unit and the high-voltage interface.

Further expedient configurations and advantages of the invention are the subject of the following description of exemplary embodiments of the invention with reference to the figures of the drawing, wherein identical reference symbols refer to identically acting component parts and wherein

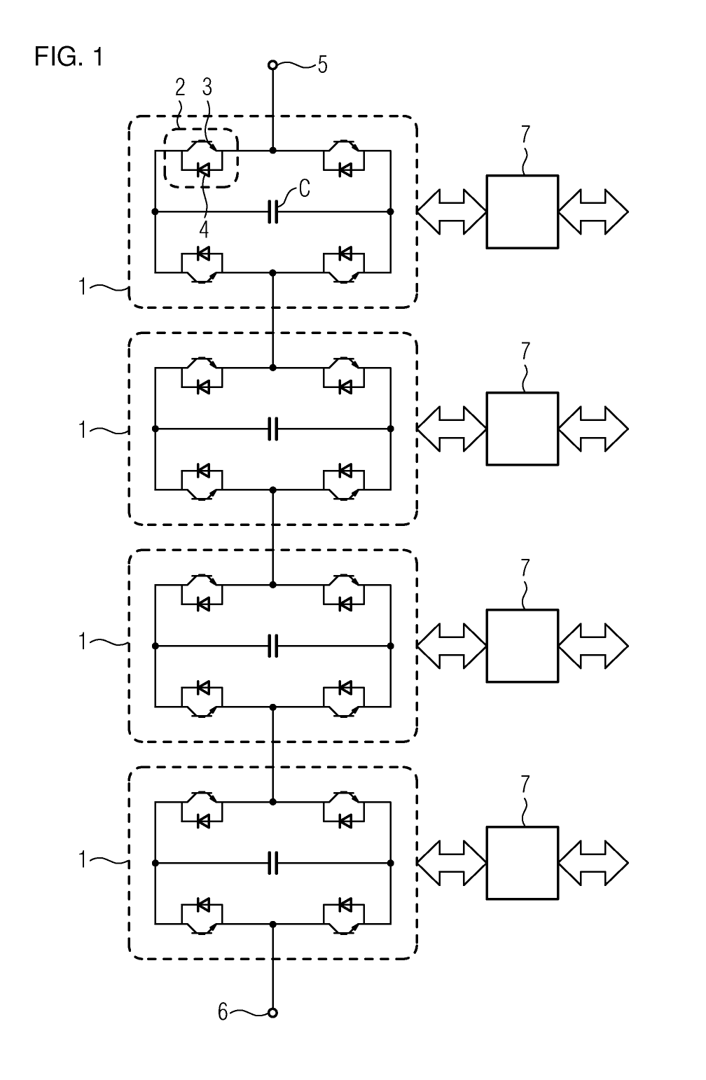

FIG. 1 shows a schematic illustration of an exemplary embodiment of a series circuit formed by semiconductor modules which is part of the device according to the invention, and

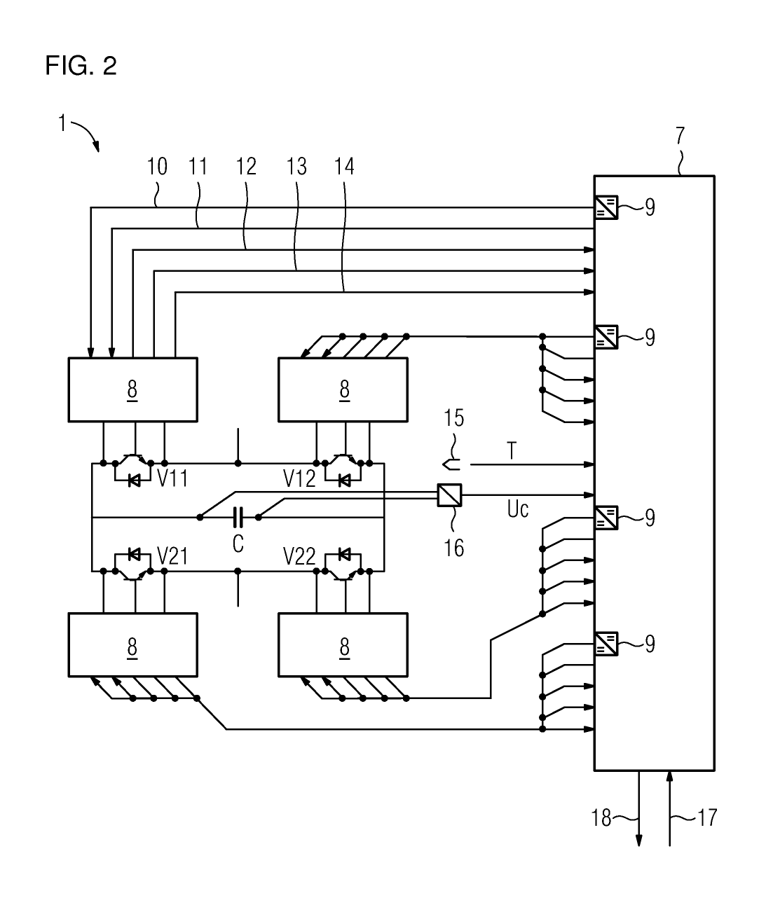

FIG. 2 illustrates the driving of power semiconductors by means of the high-voltage interface.

FIG. 1 shows a series circuit formed by semiconductor modules 1, which are in each case composed of switching modules 2. The switching modules are connected up to a capacitor C to form a so-called H circuit or full-bridge circuit, such that, depending on the position of the switching modules, the capacitor voltage U_{c} dropped across the capacitor C, the inverted capacitor voltage −U_{c} or a zero voltage is dropped across the terminals of each semiconductor module 1. In this case, each switching module comprises a turn-off power semiconductor, here an IGBT 3, and a freewheeling diode 4 reverse-connected in parallel therewith. The device shown in FIG. 1 can be connected to a phase of an AC power supply system, for example, and serves for suppressing harmonics that may form in the AC power supply system, for power factor correction, for voltage stabilization or the like. Connection terminals 5 and 6 serve for connection to the phase of the AC voltage power supply system. In the case of a three-phase AC power supply system, three of such series circuits form a configuration of the device according to the invention. A device comprising valve branches in accordance with the series circuit in FIG. 1 is also referred to as a multi-level converter.

A high-voltage interface 7 serves for driving the four IGBTs of a semiconductor module 1, said high-voltage interface being connected to a low-voltage control unit (not illustrated pictorially in FIG. 1) via potential-isolating optical waveguides. The high-voltage interface 7 is part of a high-voltage control unit (furthermore likewise not illustrated in FIG. 1). In a departure from this, the high-voltage control unit consists only of the high-voltage interface.

FIG. 2 shows the driving of the drivable power semiconductors V11, V12, V21 and V22 by the high-voltage interface 7 in more detail. In particular, it can be discerned that each of the drivable power semiconductors V11, V12, V21 and V22 is connected to the high-voltage interface 7 via a so-called gate unit 8. In practice, the gate unit 8 is often referred to as a gate driver. It serves for generating the drive signals for the respective gate connection of the power semiconductor connected to it. In order to supply each gate unit 8 with power, the high-voltage interface comprises a high-voltage power supply 9 for each gate unit 8. In this case, each power supply unit 9 is connected to the gate unit via a cable connection 10. A signal line 11 serves for transmitting the turning-on and turning-off signals which are received and forwarded by the high-voltage interface 7.

Furthermore, each gate unit 8 has state sensors connected to the high-voltage interface 7 via signal lines 12, 13 and 14. In this case, the high-voltage interface 7 is designed for receiving and processing the state signals of the state sensors. The processing is effected with the aid of an internal logic implemented in the high-voltage interface. Said logic is also designed for altering, generating or suppressing turn-on and turn-off signals if this is necessary on the basis of the state signals acquired.

The temperature sensor 15 (merely indicated schematically) detects a temperature averaged over all the switching modules 2 of the semiconductor module 1.

The determined capacitor voltage values U_{c} and the temperature values T are processed by the high-voltage interface 7, an internal logic of the high-voltage interface 7 determining whether turning-on and turning-off signals are generated or suppressed.

Two optical waveguides 17 and 18 (merely indicated schematically) serve for connecting the high-voltage interface 7 to a low-voltage interface close to ground potential, said low-voltage interface not being illustrated pictorially in FIG. 2, data being received from the low-voltage control unit (not shown) via the optical waveguide 17 and data being sent from the high-voltage interface 7 to the low-voltage control unit via the optical waveguide 18.

The high-voltage interface 7 is advantageously a so-called field programmable gate array or FPGA. Such FPGAs are programmable semiconductor components which are known as such, and so they need not be discussed in any greater detail at this point.

1-8. (canceled)

9. A device for converting an electric current or for forming an electric voltage, the device comprising:
series-connected semiconductor modules each having drivable power semiconductors;
a high-voltage control unit having a high-voltage interface at a potential of one of said semiconductor modules;
a low-voltage control unit close to ground potential;
at least one optical waveguide connecting said low-voltage control unit to said high-voltage interface of said high-voltage control unit; and
signal lines connecting said high-voltage interface to at least two of said drivable power semiconductors.

10. The device according to claim 9, wherein said high-voltage interface is configured for receiving control signals through one optical waveguide connected thereto and for distributing the received control signals to said drivable power semiconductors connected thereto.

11. The device according to claim 9, which further comprises state sensors connected to said high-voltage interface, said high-voltage interface receiving measurement signals of said state sensors.

12. The device according to claim 11, wherein said high-voltage interface is configured for processing the measurement signals of said state sensors and for driving said drivable power semiconductors connected thereto in a manner dependent on the measurement signals.

13. The device according to claim 9, which further comprises a power supply unit close to ground potential, and a potential-isolating connecting device connecting said power supply unit close to ground potential to said high-voltage interface for providing power supply to said high-voltage interface from said power supply unit close to ground potential.

14. The device according to claim 9, which further comprises a high-voltage power supply at the potential of one of said semiconductor modules, said high-voltage power supply being connected to said high-voltage interface for power supply thereof.

15. The device according to claim 13, which further comprises gate units each connecting a respective one of said drivable power semiconductors to said high-voltage interface, said gate units each being configured for generating a drive signal for a respective drivable power semiconductor of said semiconductor module.

16. The device according to claim 15, which further comprises power supplies, said high-voltage interface supplying said gate units with power through said power supplies.
